(19) United States
(12) Patent Application Publication
(10) Pub. No.: US 2021/0027402 A1
(43) Pub. Date: Jan. 28, 2021

(54) SYSTEMS AND METHODS FOR REAL-TIME FACILITY MANAGEMENT

(71) Applicant: INFAX, INC., Alpharetta, GA (US)

(72) Inventors: David Michael Davis, Alpharetta, GA (US); Bryan Davis, Alpharetta, GA (US); Tracy Davis, Alpharetta, GA (US)

(21) Appl. No.: 16/518,679

(22) Filed: Jul. 22, 2019

(51) Int. Cl. G06Q 50/16; G06Q 30/02; G06Q 10/00; G06N 5/02

(52) U.S. Cl. CPC G06Q 50/163; G06N 5/02; G06Q 10/20; G06Q 30/0202

(57) ABSTRACT

The present systems and methods generally relate to facilitating real-time monitoring and maintenance of high-volume facilities. Using a unique combination of components, the present systems and methods can assess facility maintenance requirements and assign employees to facilities as needed, as well as predict future staffing requirements. For example, in certain embodiments, the present systems and methods leverage sensor and signal transmitting technologies to record facility activity and respond accordingly with appropriate staff assignments.

### TECHNICAL FIELD

The present systems and methods relate generally to facility management, and more particularly to systems and methods for monitoring facility usage levels, quality control, and maintenance requirements in real time.

### BACKGROUND

An often undervalued aspect of any customer experience is the quality of the given facility (e.g., restroom, cafeteria, retail store, etc.) to which the customer is subjected. Facility management is a key operational concern that can prove challenging in high-volume locations with rapidly-changing conditions due to usage. Failure to adequately monitor and respond to such changing conditions in facilities can amount to a gradual degradation in quality of the facility and a corresponding decline in customer satisfaction.

Traditionally, facility management has largely been a static operation that did not account for the inherently dynamic nature of a public facility. Maintenance efforts occurred on a set schedule, customer usage was based on potentially speculative estimates, and management involvement occurred only upon review of reports prepared by staff members. The challenge with this structure, however, is the lack of responsiveness to real-time conditions, coupled with the lack of data points for management to make meaningful decisions. Each facility is its own dynamic entity, and improving customer interactions with facilities requires structured management and analysis of data and operations.

Currently, a centralized system for managing facility operational facets, such as staff location, cleaning time, occupancy data, maintenance requirements, customer feedback, and other facility components does not exist. Therefore, there is a long-felt but unresolved need for a system or method that can monitor, manage, and analyze high-volume facilities in real-time.

### BRIEF SUMMARY OF THE DISCLOSURE

Briefly described, and according to one embodiment, aspects of the present disclosure generally relate to systems and methods for monitoring facility usage levels and ensuring appropriate maintenance and staffing requirements. Historically, facility management has largely been conducted in a “manual” fashion without the guidance of substantial data to assist in the decision making process. In particular embodiments, facility management entailed a scheduled cleaning by a maintenance worker, who would then report the completion status to a manager along with any irregularities observed. The manager would then review the report at his or her leisure and make facility adjustment decisions at that time. According to various aspects of the present disclosure, the present systems and methods allow for real-time facility management, and give facility managers the ability to monitor customer movement, report accurate usage times, and improve deployment of personnel, such that cleaning schedules and other needs are responsive to facility needs.

In various embodiments, the present system includes throughput monitoring devices (e.g., cameras, motion sensors, etc.) to monitor movement and facilitate the collection of customer usage statistics. In one embodiment, the system employs a wireless (e.g., Bluetooth, 3G, 4G, WiFi, RFID, Zigbee, etc.) tracking system to monitor employee location and aid in improving staff member dispatch efficiency. In another embodiment, customer feedback devices (e.g., tablet computers, iPads, etc.) are employed to provide real-time alerts and improve the quality of data collection. In some embodiments, the present system includes customer experience displays (e.g., televisions, monitors, etc.), such that relevant data and other useful information are shared with the public in order to improve customer experience and confidence levels. Furthermore, in particular embodiments related to restroom facilities, the present system employs a smart lighting and latch mechanism whereby stall occupancy data may be displayed in a readily discernible fashion.

According to a particular embodiment, the present system includes software for aggregating and collecting the data gathered by the various system components (e.g., throughput monitor devices, wireless tracking systems, passenger feedback devices, experience displays, smart lighting and latch mechanisms, etc.). In various embodiments, the software may have features including, but not limited to: a map/location feature for monitoring staff member locations, a mechanism for communicating to staff members (e.g., email, text messaging, voice messaging, etc.), work order management integration, a statistical analysis of throughput and trends, a ranking display based on selected performance metrics, an aggregate view of customer survey data and staff performance data, and a predictive analysis engine.

In various embodiments, the predictive analysis engine employs algorithms for estimating expected facility usage based on aggregated external information (e.g., weather information, flight information at airports, etc.). In certain embodiments, the predictive analysis engine may include segmentation, for example, estimating customer count by time of day, as well as by specific areas of the facility and/or other external data (e.g., arrivals or departures as related to airports).

In one embodiment, a smart restroom is contemplated that includes and combines features of the present disclosure. In this embodiment, the smart restroom may be located within an airport or other high traffic area. In particular embodiments, the smart restroom includes throughput monitoring devices to count and record the number of restroom users at any given time. In various embodiments, the smart restroom further includes customer experience displays to display up-to-date restroom information to current and potential restroom users. In certain embodiments, feedback devices that allow users to express opinions regarding the quality, or state, of the restroom, may be included in the smart restroom. In one or more embodiments, employees may be tracked via wireless tracking systems that monitor at least when an employee enters, exits, or is in close proximity to the smart restroom. In various embodiments, the smart restroom includes a restroom management system that collects, aggregates, and analyzes data received from the various components of the smart restroom. In particular embodiments, the restroom management system includes a predictive analysis engine that may incorporate and analyze flight data and other airport statistics, to estimate future restroom usage.

According to particular embodiments, the present disclosure generally describes a system for facilitating real-time facility monitoring and maintenance, including: one or more throughput sensors physically installed within or in close proximity to a facility and configured to track entry and exit of users to and from the facility; and a server operatively connected to the one or more throughput sensors and including a processor operative to: receive real-time throughput data from the one or more throughput sensors indicative of users entering or exiting the facility; process the real-time throughput data to determine if one or more thresholds with respect to user throughput are met; and upon determination that one or more thresholds are met, initiating an action with respect to the facility.

In particular embodiments, the present disclosure describes the system herein, further including one or more wireless sensors physically located within or near the facility and operable to track the physical locations of agents of the facility. In at least one embodiment, the present disclosure describes the system herein, further including a plurality of wireless tracking devices worn by the agents of the facility, wherein the one or more wireless sensors receive location data from the wireless tracking devices indicative of the physical locations of the agents. In certain embodiments, the present disclosure describes the system herein, wherein the processor is further operative to receive the location data from the one or more wireless sensors and process the location data to dispatch one or more agents to particular locations within the facility. In various embodiments, aspects of the present disclosure generally describe the system herein, further including at least one management display device capable of displaying data relating to the facility; and wherein the server is further operatively connected to the at least one management display device and the processor is operative to display the real-time throughput data and/or analytics relating to the real-time throughput data on the at least one management display device. In some embodiments, the present disclosure describes the system herein, further including one or more interactive user display devices physically installed within or near the facility. In one or more embodiments, the present disclosure describes the system herein, wherein the one or more interactive user display devices display information about the current status of the facility. In at least one embodiment, the present disclosure describes the system herein, wherein the one or more interactive user display devices are operative to receive information input from facility users regarding one or more aspects of the facility.

In various embodiments, aspects of the present disclosure generally describe the system herein, further including a predictive analysis engine that is operatively connected to the server and a third party data system and is operable to provide predictive data to the server. In some embodiments, the present disclosure describes the system herein, wherein the predictive analysis engine predicts an estimated user throughput for the facility for a given time period based on historical user throughput data in the facility. In one or more embodiments, the present disclosure describes the system herein, wherein the third party data system includes an airline flight management system, wherein the facility includes an airport restroom, and wherein the users include airline passengers. In particular embodiments, the present disclosure describes the system herein, wherein the third party data system includes an event management ticketing system, the facility includes an event venue restroom, and the users include event attendees. In at least one embodiment, the present disclosure describes the system herein, wherein the predictive analysis engine predicts an estimated user throughput for the airport restroom for a given time period based on anticipated airline passenger data received from the airline flight management system. In one embodiment, the present disclosure describes the system herein, wherein the predictive analysis engine predicts an estimated user throughput for the event venue restroom for a given time period based on ticket sale data received from the event management ticketing system. In some embodiments, the present disclosure describes the system herein, wherein the facility includes a restroom or washroom. In certain embodiments, the present disclosure describes the system herein, further including a plurality of stall monitoring devices operatively connected to a plurality of restroom stalls, wherein the stall monitoring devices each include a visual indicator that indicates whether or not a respective stall is occupied or empty. In various embodiments, the present disclosure describes the system herein, wherein the plurality of stall monitoring devices each include an electronic latch monitoring system that determines if a restroom stall latch is open or closed. In certain embodiments, the present disclosure describes the system herein, wherein the action includes dispatching one or more facility agents to clean the facility.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment, according to one embodiment of the present disclosure.

FIG. 2 illustrates an exemplary system architecture, according to one embodiment of the present disclosure.

FIG. 3 illustrates an exemplary predictive analysis process, according to one embodiment of the present disclosure.

FIG. 4 illustrates an exemplary throughput monitor configuration diagram, according to one embodiment of the present disclosure.

FIG. 5 illustrates an exemplary wireless device configuration diagram, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to monitoring the movement of people and assets to help public and private facilities (e.g., restrooms, cafeterias, malls, retail stores, restaurants, etc.) improve the overall customer experience. Historically, facility management has largely been conducted in a “manual” fashion without the guidance of substantial data to assist in the decision making process. In particular embodiments, facility management entailed a scheduled cleaning by a maintenance worker, who would then report the completion status to a manager along with any irregularities observed. The manager would then review the report at his or her leisure and make facility adjustment decisions at that time. According to various aspects of the present disclosure, the present systems and methods allow for real-time facility management, and give facilities the ability to monitor customer movement, report accurate usage times, and improve deployment of personnel, such that cleaning schedules and other needs are responsive to facility needs.

In various embodiments, the present system includes throughput monitoring devices (e.g., cameras, motion sensors, etc.) to monitor movement and facilitate the collection of customer usage statistics. In one embodiment, the system employs a wireless (e.g., Bluetooth, 3G, 4G, WiFi, RFID, Zigbee, etc.) tracking system to monitor employee location and aid in improving staff member dispatch efficiency. In another embodiment, customer feedback devices (e.g., tablet computers, iPads, etc.) are employed to provide real-time alerts and improve the quality of data collection. In some embodiments, the present system includes customer experience displays (e.g., televisions, monitors, etc.), such that relevant data and other useful information are shared with the public in order to improve customer experience and confidence levels. Furthermore, in particular embodiments related to restroom facilities, the present system employs a smart lighting and latch mechanism whereby stall occupancy data may be displayed in a readily discernible fashion.

According to a particular embodiment, the present system includes software for aggregating and collecting the data gathered by the various system components (e.g., throughput monitor devices, wireless tracking systems, passenger feedback devices, experience displays, smart lighting and latch mechanisms, etc.). In various embodiments, the software may have features including, but not limited to: a map/location feature for monitoring staff member locations, a mechanism for communicating to staff members (e.g., email, text messaging, voice messaging, etc.), work order management integration, a statistical analysis of throughput and trends, a ranking display based on selected performance metrics, an aggregate view of customer survey data and staff performance data, and a predictive analysis engine.

In various embodiments, the predictive analysis engine employs algorithms for estimating expected facility usage based on aggregated external information (e.g., weather information, flight information at airports, etc.). In certain embodiments, the predictive analysis engine may include segmentation, for example, estimating customer count by time of day, as well as by specific areas of the facility and/or other external data (e.g., arrivals or departures as related to airports).

In one embodiment, a smart restroom is contemplated that includes and combines features of the present disclosure. In this embodiment, the smart restroom may be located within an airport or other high traffic area. In particular embodiments, the smart restroom includes throughput monitoring devices to count and record the number of restroom users at any given time. In various embodiments, the smart restroom further includes customer experience displays to display up-to-date restroom information to current and potential restroom users. In certain embodiments, feedback devices that allow users to express opinions regarding the quality, or state, of the restroom, may be included in the smart restroom. In one or more embodiments, employees may be tracked via wireless tracking systems that monitor at least when an employee enters, exits, or is in close proximity to the smart restroom. In various embodiments, the smart restroom includes a restroom management system that collects, aggregates, and analyzes data received from the various components of the smart restroom. In particular embodiments, the restroom management system includes a predictive analysis engine that may incorporate and analyze flight data and other airport statistics, to estimate future restroom usage.

### Exemplary Embodiments

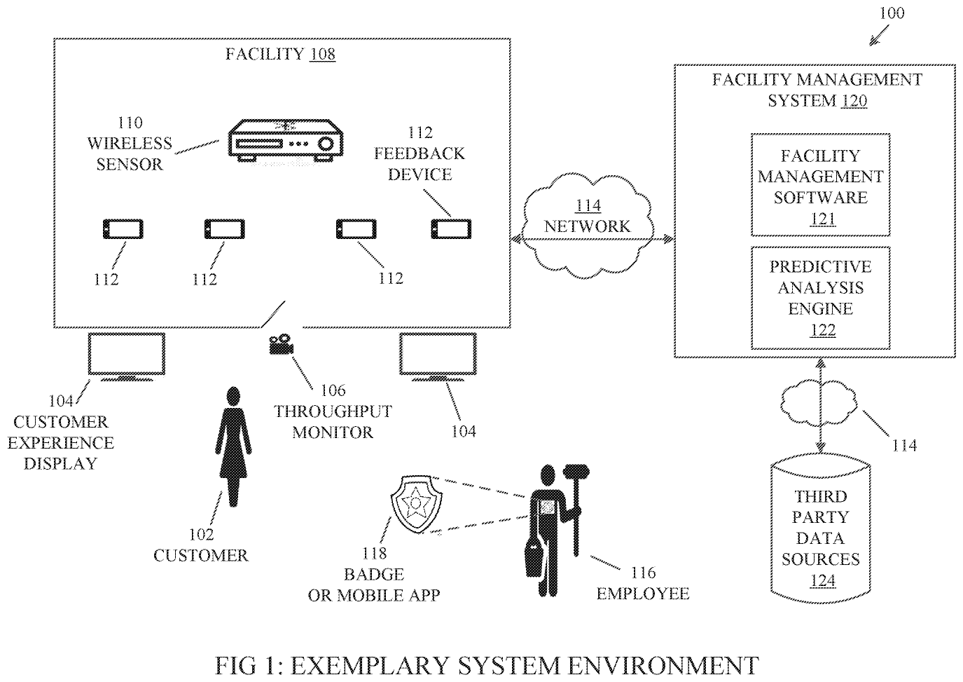

Referring now to the figures, for the purposes of example and explanation of the fundamental processes and components of the disclosed systems and methods, reference is made to FIG. 1, which illustrates an exemplary, high-level overview 100 of one embodiment of the systems and methods herein. As will be understood and appreciated, the exemplary, high-level overview 100 shown in FIG. 1 represents merely one approach to, or embodiment of, the present system, and other aspects are used according to various embodiments of the present system. In particular, FIG. 1 depicts a particular example in which a customer 102 enters a facility 108 that logs her presence via a throughput monitor 106; the customer leaves feedback regarding the cleanliness of the facility using a feedback device 112; then, based on the feedback, customer count, and other data, facility management software 121 alerts a nearby employee 116 that the facility 108 needs attention. Further, FIG. 1 depicts how various systems in this environment interact in at least one embodiment of the systems and methods described herein.

As shown in FIG. 1, a customer 102 approaches and prepares to enter a facility 108 (e.g., cafeteria, restroom, etc.). In various embodiments, the exterior or interior of the facility may include customer experience displays 104 to keep customers informed of relevant information (e.g., number of current facility users, availability of facility resources, location of additional facilities, etc.). Upon entering the facility, in particular embodiments, the customer's presence may be logged via a throughput monitor 106 (e.g., camera, sensor, etc.) such that the number of facility users may be recorded and analyzed. While in the facility 108, the customer 102 may use a feedback device 112 (e.g., tablet computer, iPad, etc.) to complete a customer satisfaction survey or provide other suitable indication of facility quality. As shown in FIG. 1, the facility may include a wireless sensor device 110 (e.g., Bluetooth beacon, Bluetooth computer, WiFi device, RFID device, 3G, 4G, or 5G device, etc.) that is linked to employee badges 118 that emit wireless signals, such that employees 116 may be tracked and dispatched on a substantially as-needed basis to clean or otherwise service the facility 108. In certain embodiments, employee tracking may be facilitated via WiFi, 3G, 4G, 5G, RFID cards, or any other suitable tracking mechanism (e.g., non-wireless touch, or input-based tracking). In some embodiments, employee tracking is facilitated by a beacon sensor located in the facility that is linked to a signal emitted from an employee's mobile device (e.g., smartphone, tablet computer, iPad, etc.). In one or more embodiments, an employee's mobile device may also be operable to execute employee management software. In particular embodiments, employee management software may allow employees to track inventory (e.g., soap, toilet paper, etc.), record cleaning times, monitor task completion (e.g., swept the floor, wiped the counters, etc.), report issues, and perform other suitable functions.

In particular embodiments, a facility management system 120 includes facility management software 121 and a predictive analysis engine 122. In various embodiments, the data collected by the various facility components (e.g., throughput monitor 106, wireless sensor device 110, feedback device 112, experience display 104, etc.) are aggregated and analyzed by facility management software 121. In one or more embodiments, the predictive analysis engine 122 may be used to estimate and manage future facility usage. In various embodiments, the predictive analysis engine may receive input from third party data sources 124, including but not limited to: airline flight data, historical traffic patterns, event schedules, user activity schedules, third party employee schedules, building maintenance plans, and any other suitable data sources. In one embodiment, the facility management system 120 may operate locally (e.g., on a hard drive). In another embodiment, the facility management system may operate remotely (e.g., on a network, a virtual server, etc.). Further, as shown, the various components of this exemplary environment are operatively connected via one or more networks 114.

In one embodiment, the network 114 may be, but is not limited to the Internet, and may involve the usage of one or more services (e.g., a Web-deployed service with client/service architecture, a corporate Local Area Network (LAN) or Wide Area Network (WAN), a cellular data network, or through a cloud-based system). Moreover, as will be understood and appreciated by one having ordinary skill in the art, various networking components like routers, switches, hosts, etc. are typically involved in these communications. Although not shown in FIG. 1, such communications may include, in various embodiments, one or more secure networks, gateways, or firewalls that provide additional security from unwarranted intrusions by unauthorized third parties and cyber-attacks.

Assume, as a discussion example, that the customer 102 is a passenger at an airport seeking to use the restroom (e.g., facility 108) prior to boarding her flight. In deciding which restroom to choose, the customer views the customer experience display 104 outside of the nearest restroom. The customer experience display includes information, including but not limited to: restroom gender specification, whether the restroom is open or closed, the restroom user count, stall occupancy data, stall availability wait time, attendant present data, time of last cleaning, guidance to nearest available restroom without a wait time, etc. In various embodiments, the customer experience display 104 receives data and is updated by the facility management software 121, which facilitates management of the restroom (e.g., facility 108).

Upon viewing the information on the customer experience display 104, the customer 102 decides to use the nearest restroom and proceeds to the entrance where the customer's presence is logged by a counting camera (e.g., throughput monitor 106). Prior to exiting the restroom, the customer engages a feedback device 112 mounted on a wall in the restroom, and logs a complaint that the restroom is below acceptable cleanliness levels and needs attention (e.g., trash receptacles are full, counters are excessively wet, stalls are dirty, etc.). The customer 102 then leaves the restroom and the counting camera (e.g., throughput monitor 106) logs her exit.

Continuing with the current example, the facility management software 121 records the customer's 102 movement as logged by the counting camera, and updates the customer experience display 104 to account for the customer entering and exiting the restroom. The presence of the customer in the restroom (e.g., facility 108), and/or the receipt of the customer's feedback from the feedback device 112, among other data (e.g., usage statistics, cleaning history, predictive analysis engine 122, etc.) may trigger the facility management software to determine that the restroom is in need of cleaning and may notify an employee 116 accordingly.

In the present example, the most proximate employee may be located and assigned via wireless tracking devices in employees' badges 118 and/or mobile devices (such as mobile phones, smart phone devices, etc.). Upon entering the restroom to perform the cleaning, the employee's badge (or mobile device), equipped with a wireless transmitter, is registered by a wireless sensor device 110 (e.g., Bluetooth beacon, Bluetooth computer, WiFi device, RFID device, 3G, 4G, or 5G device, etc.) located in the restroom. The facility management software 121 receives this data and updates the customer experience displays 104 accordingly. Upon completion of cleaning, the employee 116 leaves the restroom and the wireless sensor device registers the employee's exit. The facility management software again receives this data and updates the customer experience displays accordingly.

As will be understood from the discussions herein, the above particular example is merely exemplary functionality of the systems and methods described herein. For example, the above describes a customer using a restroom at an airport, but the systems and methods herein may be useful for any use in connection with facility management in high volume environments such as train stations, stadiums, shopping malls, and the like.

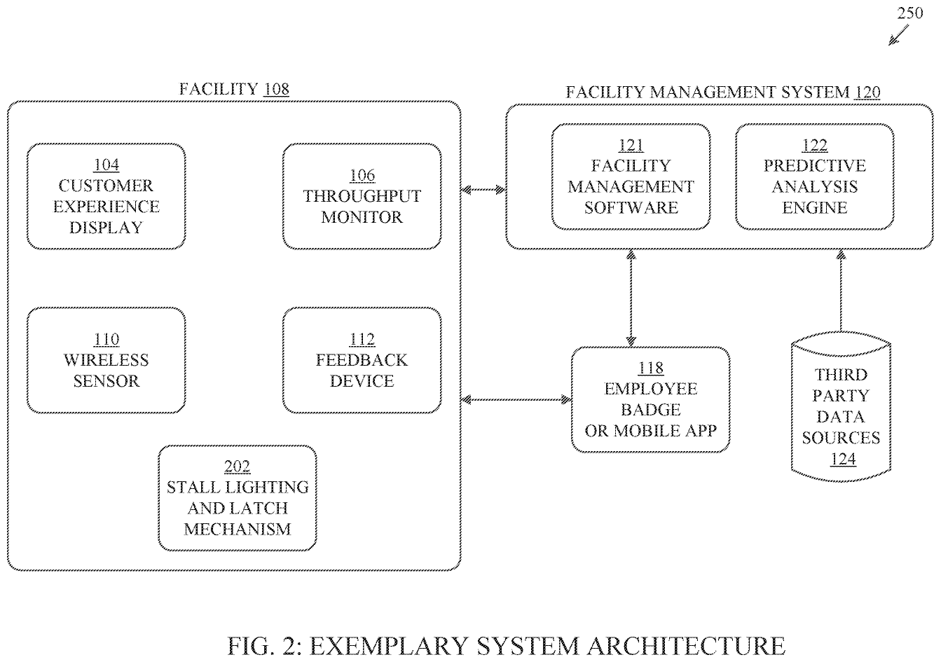

Turning now to FIG. 2, an exemplary system architecture 200 is shown, according to one embodiment of the present disclosure. In various embodiments as discussed above, the system includes a series of components located in, around, or nearby a facility 108, operable to monitor, manage, and analyze the facility. In addition to the described components, the system architecture may include one or more modules. For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by one or more processors in communication with memory or other storage means. Modules may be integral to one or more servers, or be loaded and executed by one or more servers. One or more modules may be grouped into an engine or an application. Additionally, the system architecture may include any computing device (e.g., desktop computer, laptop, servers, tablets, etc.), combination of computing devices, software, hardware, combination of software and hardware, database (e.g., stored in the cloud or on premise, structured as relational, etc.), or combination of databases that is capable of performing, or facilitating performance of, the functionality disclosed herein.

In one embodiment, the series of components include a customer experience display 104 for providing customers with information concerning the facility prior to, or during, their use of the facility; a throughput monitor 106 for counting and recording the number of facility users as they enter and exit the facility; a wireless sensor device 110 (e.g., Bluetooth beacon, Bluetooth computer, WiFi device, RFID device, 3G, 4G, or 5G device, etc.) for monitoring the presence of janitorial employees (wearing wireless-equipped employee badges 118 or carrying mobile devices equipped with employee management software) working in the facility 108; and a feedback device 112 for allowing customers to rate, review, and/or comment on the conditions and/or other suitable details of the facility.

In particular embodiments, the system also includes a facility management system (“FMS”) 120 which facilitates the processing, analyzing, and organizing of the data collected by the series of components located in, around, or nearby the facility 108. In one or more embodiments, the FMS may include facility management software 121 and a predictive analysis engine 122, whereby the predictive analysis engine is operatively connected to third party data sources 124. In certain embodiments, the FMS 120 may be responsible for aggregating the collected data and accessibly presenting the information. In particular embodiments, the FMS may include map display and functionality for monitoring employee 116 locations. In these embodiments, the FMS may populate the map with employee location data continuously collected from wireless transmitters (e.g., Bluetooth, WiFi, 3G, 4G, Zigbee, etc.) located on employee badges 118 and/or mobile devices. In certain embodiments, the FMS may populate the map with employee location data gathered from employee mobile device (e.g., smartphone, tablet computer, iPad, etc.) GPS signals. In various embodiments, the FMS 120 may include a mechanism for communicating with employees. In these embodiments, the FMS may include communication mechanisms including but not limited to, instant messaging, voice messaging, text messaging, email, and other suitable messaging protocols.

In various embodiments the FMS 120 may provide for a statistical analysis of throughput and trends. In these embodiments, the FMS may aggregate the throughput data and provide for visual segmentation of user traffic into distinct segments, such as area or zone (e.g., of airport), facility 108 (if multiple), date, time of day, etc. In some embodiments, the FMS may include an aggregate view of customer survey data collected by feedback devices 112, and employee performance data as generated through performance reviews and the like. In the event that multiple facilities are managed by the FMS, in particular embodiments, the FMS 120 may include a system to rank and display the multiple facilities 108. In these embodiments, the multiple facilities may be ranked by facility cleaning time, customer count, average customer usage time, customer interactions with feedback devices 112, etc. In various embodiments, the FMS 120 may provide for work order management integration, such that facility cleaning requests can be entered, monitored, updated, or terminated as needed.

Additionally, and as will be further discussed herein, in some embodiments, the FMS includes a predictive analysis engine 122 for estimating expected facility usage over a given period. In particular embodiments, the predictive analysis engine receives input both internally from the various system components (e.g., throughput monitor 106, wireless sensor device 110, feedback device 112, experience display 104, etc.), and externally from third party data sources 124 (e.g., airline flight information, venue ticket sale information, historical traffic patterns, event schedules, user activity schedules, third party employee schedules, building maintenance plans, and any other suitable data sources). In various embodiments, the predictive analysis engine may process received inputs to predict how many users a facility may expect at a future time, such that a facility manager (or other administrator) may allocate resources accordingly. For example, based on historical traffic patterns and current system usage as received by the various system components, the predictive analysis engine 122 may determine that between 2:00 pm and 11:00 pm on two Mondays from today, the facility can expect between 1,200 and 1,500 users. Based on this predictive analysis, a facility manager may schedule the appropriate number of staff members to handle the expected volume of traffic between 2:00 pm and 11:00 pm on two Mondays from today.

Continuing with FIG. 2, in some embodiments, and as discussed above, the facility 108 may be a restroom. In these embodiments, the series of components located in, around, or nearby the facility may include stall lighting and latch mechanisms 202. In particular embodiments, the stall lighting and latch mechanism may include a color changing light visibly located above each stall in the restroom (e.g., facility 108), and a corresponding latch on each stall door in operative communication with the corresponding color changing light. In one or more embodiments, when a stall is unoccupied (e.g., the stall latch is in an unlocked position) the color changing light above the stall will illuminate in a color (e.g., green), such that restroom users may readily discern that the stall is available. In these embodiments, when a customer 102 occupies a stall and places the stall latch in a locked position, the color changing light will illuminate in a different color (e.g., red), such that restroom (e.g., facility 108) users will be on notice that a particular stall is unavailable. In particular embodiments, the color changing light may illuminate in a different color upon various triggers separate and distinct from placing the stall latch in a locked position. Triggers may include, but are not limited to: detection of customer movement in the stall, detection of an electronic signal in the stall (e.g., from a customer's mobile device), manual activation (e.g., pressing an “occupied” button on a display in the stall), and any other suitable trigger.

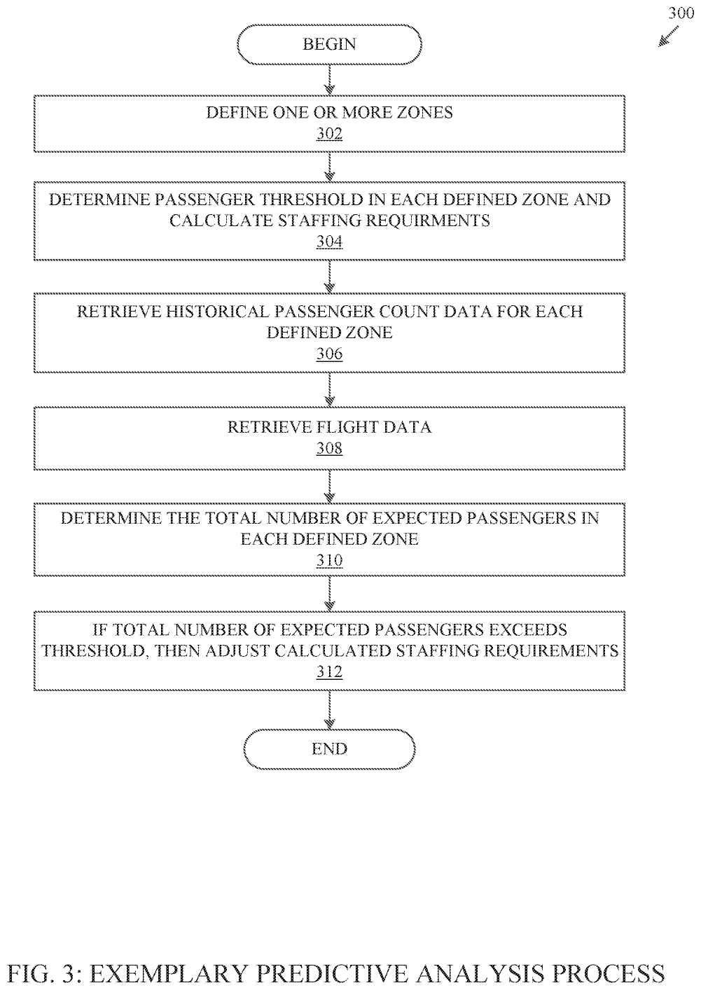

Now referring to FIG. 3, an exemplary predictive analysis process 300 is shown, according to one embodiment of the present disclosure. In this embodiment, the predictive analysis process will be discussed in reference to facilities (e.g., restrooms) at an airport. For example, a restroom facility manager tasked with staff scheduling, would benefit from having access to an accurate future estimate of passenger count and restroom usage, such that the facility manager may schedule staff members according to need. Thus, it is important to establish a process by which data sources (internal and external) are retrieved and analyzed, such that airport passenger traffic may be estimated at any given time, and restroom usage may be predicted accordingly. As will be understood by one having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown.

In one embodiment, and as shown in FIG. 3, the exemplary process begins with step 302, where the system is configured to define one or more zones. In various embodiments, a zone may be defined by its proximity to a facility or other suitable point of reference (e.g., a restroom in an airport). In particular embodiments, a zone may be defined in terms of other pre-defined areas (e.g., gates and/or terminals at an airport, seating sections at a stadium, table groupings at a cafeteria, etc.). In one or more embodiments, a zone may be defined by dimensional characteristics (e.g., 20 ft², 30 ft², 50 ft², etc.). In various embodiments, the system may be configured to define one or more zones, such that data collection, processing, and analyzing may be segmented by the one or more zones.

At step 304, the system is configured to determine the passenger threshold in each defined zone and calculate staffing requirements. In various embodiments, the passenger threshold may be determined by the size or occupancy level of the restroom (e.g., facility). In some embodiments, the passenger threshold may be determined by current staff levels. In particular embodiments, the passenger threshold may provide a baseline for calculating the facility maintenance staffing requirements. In one or more embodiments, the system may apply any suitable staff calculation method in calculating the facility maintenance staffing requirements (e.g., quantification, relief factor, benchmarking, etc.)

Turning now to step 306, the system retrieves the historical passenger count data for each defined zone. In various embodiments, the system may retrieve the historical passenger count data from an internal database (e.g., as previously calculated by the system), or from an external database (e.g., an airport records server). In one or more embodiments, the system may retrieve the historical passenger count data from a variety of time periods, including but not limited to: one day prior, one week prior, one month prior, six months prior, one year prior, etc.

At step 308, the system is configured to retrieve flight information for all flights arriving at, and departing from, gates located in each defined zone. In various embodiments flight information retrieved may include, but is not limited to: flight number, gate number, time of arrival, tail number, passenger count, etc. In particular embodiments, the system may determine aircraft type and flight capacity based on the tail number of a given aircraft. In one embodiment, if an exact passenger count was not included with the flight information, then the system will assume one hundred percent flight capacity.

Next, at step 310, the system determines the total number of passengers expected in each defined zone. In various embodiments, the system determines the total passenger count in each defined zone by adding the exact passenger count or the total flight capacity of each flight arriving at, or departing from, gates located in a given zone. In one or more embodiments, the system may determine the total passenger count in each defined zone on a segmented basis (e.g., hourly, daily, between 9 a.m. and 12 p.m., etc.)

At step 312, the system is configured to adjust the calculated staffing requirements if the total number of expected passengers varies from the threshold determined in step 304. If the difference between the threshold passenger levels and the total number of expected passengers as calculated in step 310 exceeds a predefined confidence level (e.g., within ten percent, within twenty percent, etc.), then the system may be configured to adjust the staffing requirements calculated at step 304. In various embodiments, the system may be configured to reduce the calculated staffing requirements if the total number of passengers is less than the determined threshold level. Conversely, in certain embodiments, the system may be configured to increase the calculated staffing requirements if the total number of passengers is greater than the determined threshold level.

Although the predictive analysis process 300 is discussed above in reference to facilities (e.g., restrooms) at an airport, the predictive analysis process may apply to facilities in various venues that experience a high volume of traffic. For example, the predictive analysis process may apply to facilities at convention centers (or arenas, stadiums, or other similar venues). In this example, the system may retrieve historical ticket sale data based on the type of event occurring (e.g., concert, soccer game, basketball game, etc.). Continuing with this example, the system may be configured to retrieve current ticket sale data, such that the system may determine the total number of expected customers in each defined zone by analyzing the seating assignments of the sold tickets. In this example, the system may then calculate and/or adjust staffing requirements based on the expected customer count.

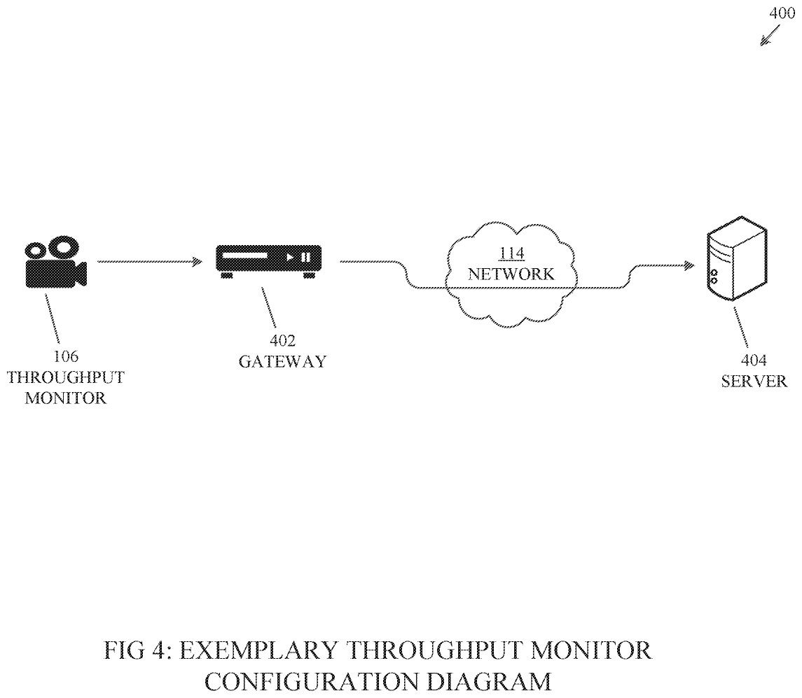

Now referring to FIG. 4, an exemplary throughput monitor configuration diagram 400 is shown, according to one embodiment of the present disclosure. In various embodiments, the throughput monitor configuration diagram includes a throughput monitor 106 for tracking and logging customers 102 entering and exiting a facility 108. In particular embodiments, the throughput monitor may be a counting camera, sensor, or other suitable device. Non-limiting examples of throughput monitors include: AXIS F1025 Sensor Unit, available at Axis Communications, 300 Apollo Drive, Chelmsford, Mass. 01824, or at www.axis.com; or ACTi Q93 People Counting Camera, available at 3 Jenner Suite 160 Irvine, Calif. 92618, or at www.acti.com. In certain embodiments, the throughput monitor configuration diagram 400 includes a gateway 402 operatively connected to the throughput monitor 106, for storing and processing video collected by the throughput monitor. In a particular embodiment, the gateway may embody a digital video receiver. Non-limiting examples of digital video receivers include: AXIS F41 Main Unit, available at Axis Communications, 300 Apollo Drive, Chelmsford, Mass. 01824, or at www.axis.com; or Samcen SCS-6100MA Fully Digital Congress Main Unit, available at Units 705, Lingyun Building Dingxin Hi-Tech Park, Honglang North-2 Rd, Bao'an District, Shenzhen, China, or at www.samcen.com. In various embodiments, the throughput monitor configuration diagram also includes a server 404 operatively connected to the gateway via a network 114. In one or more embodiments, the server may be a virtual (e.g., cloud-based) server, a platform server, an application server, or any other suitable server. In particular embodiments, the server 404 stores the data (e.g., video) processed by the gateway (e.g., digital video receiver) such that the data may be accessed and analyzed by the facility management system 120.

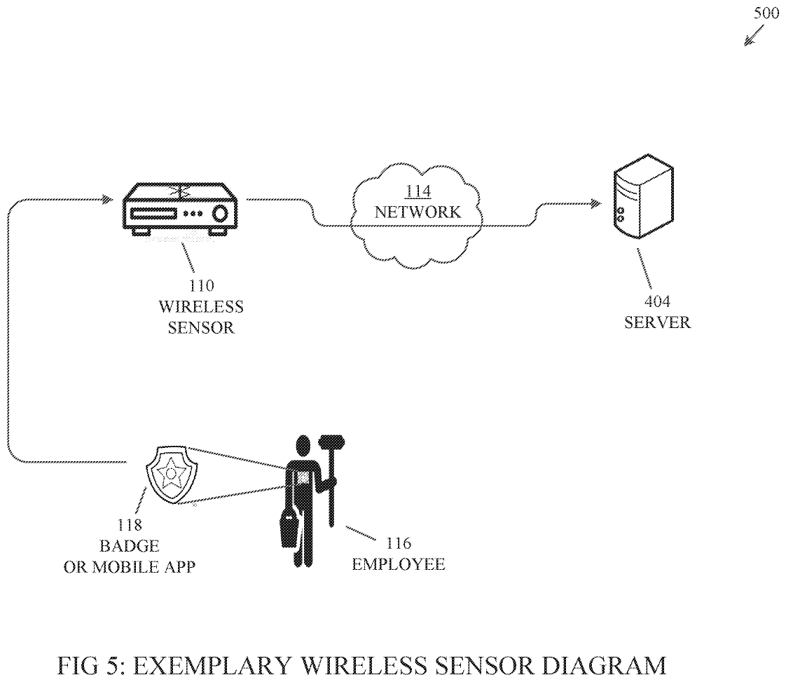

FIG. 5 shows an exemplary wireless device configuration diagram 500, according to one embodiment of the present disclosure. In one or more embodiments, the wireless device configuration diagram includes a badge 118 worn by an employee 116 (or mobile device carried by an employee), whereby the badge (or mobile device) is equipped with a Bluetooth transmitter, or any other suitable wireless transmitter (e.g., WiFi, 3G, 4G, Zigbee, etc.). In certain embodiments, the wireless device configuration diagram includes a wireless sensor device 110 for receiving wireless signals transmitted by the employee badges or employee mobile devices. In one embodiment, the wireless sensor device may include a Bluetooth beacon. In another embodiment, the wireless sensor device 110 may include a Bluetooth computer. Non-limiting examples of wireless sensor devices include: Aruba® Bluetooth Beacon, available at 3333 Scott Blvd, Santa Clara, Calif. 95054, or at www.arubanetworks.com; Sennheiser BTD 800 USB, available at Sennheiser Electronic Corporation, 1 Enterprise Drive, Old Lyme, Conn. 06371, or at en-us.sennheiser.com; or Now Micro DMP-501N/5300N, available at 1645 Energy Park Drive, Suite 100, Saint Paul, Minn. 55108, or at www.nowmicroplayers.com. In various embodiments, the wireless sensor device 110 may be included in, or in close proximity to, a facility 108, such that an employee 116 wearing a badge 118, or using a mobile device with employee management software, may track his or her time spent working in (e.g., cleaning) the facility. In particular embodiments, the wireless device configuration diagram 500 may include a server 404 operatively connected to the wireless sensor device via a network 114. In various embodiments, the server may be a virtual (e.g., cloud-based) server, a platform server, an application server, or any other suitable server. In particular embodiments, the server stores the data (e.g., employee time spent cleaning) processed by the wireless sensor device 110 such that the data may be accessed and analyzed by the facility management system 120.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

We claim:

1. A system for facilitating real-time facility monitoring and maintenance, comprising:
one or more throughput sensors physically installed within or in close proximity to a facility and configured to track entry and exit of users to and from the facility; and
a server operatively connected to the one or more throughput sensors and comprising a processor operative to:
receive real-time throughput data from the one or more throughput sensors indicative of users entering or exiting the facility;
process the real-time throughput data to determine if one or more thresholds with respect to user throughput are met; and
upon determination that one or more thresholds are met, initiating an action with respect to the facility.

2. The system of claim 1, further comprising one or more wireless sensors physically located within or near the facility and operable to track the physical locations of agents of the facility.

3. The system of claim 2, further comprising a plurality of wireless tracking devices worn by the agents of the facility, wherein the one or more wireless sensors receive location data from the wireless tracking devices indicative of the physical locations of the agents.

4. The system of claim 3, wherein the processor is further operative to receive the location data from the one or more wireless sensors and process the location data to dispatch one or more agents to particular locations within the facility.

5. The system of claim 1, further comprising at least one management display device capable of displaying data relating to the facility; and
wherein the server is further operatively connected to the at least one management display device and the processor is operative to display the real-time throughput data and/or analytics relating to the real-time throughput data on the at least one management display device.

6. The system of claim 1, further comprising one or more interactive user display devices physically installed within or near the facility.

7. The system of claim 6, wherein the one or more interactive user display devices display information about the current status of the facility.

8. The system of claim 7, wherein the one or more interactive user display devices are operative to receive information input from facility users regarding one or more aspects of the facility.

9. The system of claim 1, further comprising a predictive analysis engine that is operatively connected to the server and a third party data system and is operable to provide predictive data to the server.

10. The system of claim 9, wherein the predictive analysis engine predicts an estimated user throughput for the facility for a given time period based on historical user throughput data in the facility.

11. The system of claim 9, wherein the third party data system comprises an airline flight management system, wherein the facility comprises an airport restroom, and wherein the users comprise airline passengers.

12. The system of claim 9, wherein the third party data system comprises an event management ticketing system, the facility comprises an event venue restroom, and the users comprise event attendees.

13. The system of claim 11, wherein the predictive analysis engine predicts an estimated user throughput for the airport restroom for a given time period based on anticipated airline passenger data received from the airline flight management system.

14. The system of claim 12, wherein the predictive analysis engine predicts an estimated user throughput for the event venue restroom for a given time period based on ticket sale data received from the event management ticketing system.

15. The system of claim 1, wherein the facility comprises a restroom or washroom.

16. The system of claim 15, further comprising a plurality of stall monitoring devices operatively connected to a plurality of restroom stalls, wherein the stall monitoring devices each comprise a visual indicator that indicates whether or not a respective stall is occupied or empty.

17. The system of claim 16, wherein the plurality of stall monitoring devices each comprise an electronic latch monitoring system that determines if a restroom stall latch is open or closed.

18. The system of claim 1, wherein the action comprises dispatching one or more facility agents to clean the facility.
